(19) United States
(12) Patent Application Publication
(10) Pub. No.: US 2022/0163839 A1
(43) Pub. Date: May 26, 2022

(54) ROBOT USING LIQUID CRYSTAL DISPLAY PANEL

(71) Applicant: Chang Gung University of Science and Technology, Taoyuan City (TW)

(72) Inventors: Hsiu Min Tsai, Taoyuan City (TW); Po Hsiang Huang, Taoyuan City (TW)

(21) Appl. No.: 17/132,383

(22) Filed: Dec. 23, 2020

(30) Foreign Application Priority Data
Nov. 20, 2020 (TW) 109140657

(51) Int. Cl. G02F 1/1335; F21V 8/00; G02F 1/13357

(52) U.S. Cl. CPC G02F 1/133504; G02B 6/0031; G02F 1/133615; G02B 6/0046

(57) ABSTRACT

A robot using a liquid crystal display panel includes a mask, an LCD panel and a high-directional backlight module. The LCD is arranged close to the mask, and the backlight module is arranged on one side of the LCD panel and used to provide an extremely high directional backlight source to the liquid crystal display panel so that the image generated by the LCD panel can be projected onto the mask. By projecting images on the mask via the LCD panel, the disadvantage that the conventional projector needs to occupy a larger space is improved, and the design of the mask can be more flexible.

### BACKGROUND OF THE INVENTION

### 1. Field of the Invention

The present invention is related to a robot, and more particularly related to a robot using liquid crystal display panel.

### 2. Description of Related Art

With a longevity of the population and the advancement of medical resources, many countries have entered an aging society, and the society is accompanied by those problems such as the requirement for the elderly nursing and the medical care. Those problems are coupled with the negative growth of the labor force due to the declining birthrate, and have resulted in the shortage of medical resources and manpower. In the face of the shortage of nursing manpower, many countries have begun to include robots in their medical care plans. Hopefully, in the next few years, medical service robots will be popularized, so that more elderly people can have nursing services provided by robots at home.

Medical companion robots in hospitals, communities and homes need facial expressions to show their care for users. And other industries, which require human-computer interaction, such as sending and receiving, reception and guidance of the service industry as well as the care of the medical industry, also need robots with facial expression.

However, in order for the robot to show facial cares such as eye contact, lip sync, or expression, the robot needs a facial structure. Most of the existing practices implement a mask 11 as a diffuser and a projector 12 behind the mask 11. As shown in FIG. 1, the projector 12 projects motion images, such as eyes, mouth and face on the mask 11. The light on every point on the mask is scattered and emitted to all directions through the diffuser. Such the facial structure can be, for example, prior art 1 (Towards Retro-projected Robot Faces: An Alternative to Mechatronic and Android Faces) or prior art 2 (A life-size robot head using talking head animation for human-robot communication).

However, when the projector is used as the image display of the robot, the head area of the robot requires a larger space to place the projector, which is not conducive to the design of the robot's head shape. Therefore, a need is arisen to design different robot display devices to have the robot with a flexible design of the head shape.

### SUMMARY OF THE INVENTION

An objective of the present invention is to provide a medication intelligent device.

According to the aforementioned objective, a robot using liquid crystal display (LCD) panel includes a mask, an LCD panel and a backlight module. The LCD panel is disposed at an inner side of the mask. The backlight module is disposed at one lateral side of the LCD panel and configured to provide a very high-directional backlight for the LCD panel, and images generated by the LCD panel being able to project to the mask.

In the robot using the LCD panel, the mask is a curved diffusing plate with 3D shapes of eyes, mouth and nose.

In the robot using the LCD panel, the backlight module is a high-directional backlight module.

In the robot using the LCD panel, the backlight module includes a light source generator and a light guide element. The light source generator is configured to generate a point light source and the light guide element is configured to receive the point light source. The point light source is converted to a very high-directional backlight by the light guide element and uniformly directed to a light emitting surface of the light guide element.

In the robot using the LCD panel, the light guide element is a mirror light guide plate or a reflector.

In the robot using the LCD panel, the mirror light guide plate is inclined at an angle with respect to the LCD panel.

In the robot using the LCD panel, the point light source generated by the light generator is transmitted to the mirror light guide plate and the point light source is reflected by the mirror light guide plate and uniformly directed to the LCD panel.

In the robot using the LCD panel, the light guide element is a wedge-shaped light guide plate, and the light emitting surface of the wedge-shaped light guide plate is arranged parallel to the LCD panel and the point light source generated by the light generator is transmitted from one end of the wedge-shaped light guide plate into the wedge-shaped light guide plate and then the point light source is many times reflected inside the wedge-shaped light guide plate to be uniformly directed to the LCD panel.

In the robot using the LCD panel, the point light source is a blue laser light source with etendue limited, and the point light source is focused on the phosphor plate to excite yellow light, then the excited yellow light is combined with the blue laser light to produce white light transmitted to the wedge-shaped light guide plate.

In the robot using the LCD panel, the light source is generated by RGB light emitting diodes (LEDs) used by a pico-projector, and the RGB light source is transmitted to a dichroic mirror for combining red, blue and green LED lights, then focused at one point and enter the wedge-shaped light guide plate.

Through the robot using the liquid crystal display panel in the present invention, the liquid crystal display panel is used to replace the general projector to reduce the internal space of the robot and also make the face design of the robot more flexible.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic diagram of a conventional robot using a projector;

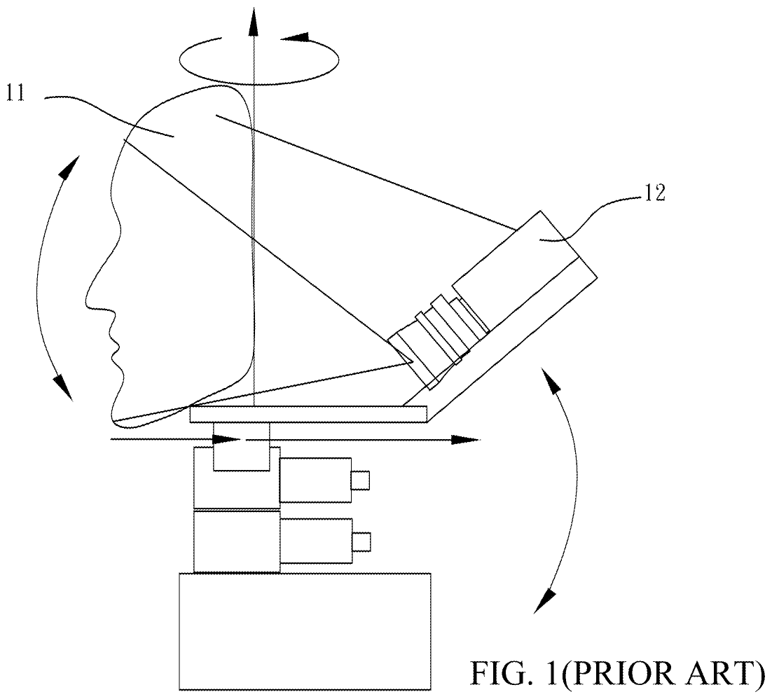

FIG. 2 is a schematic diagram of a robot in the present invention, using a liquid crystal display panel with high-directional backlight module;

FIG. 3 is a schematic diagram of a robot using a liquid crystal display panel according to the first embodiment of the backlight module in the present invention; and

FIG. 4 is a schematic diagram of a robot using a liquid crystal display panel according to the second embodiment of the backlight module in the present invention.

### DETAILED DESCRIPTION OF THE PREFERRED EMBODIMENT

These and other aspects of the embodiments herein will be better appreciated and understood when considered in conjunction with the following description and the accompanying drawings.

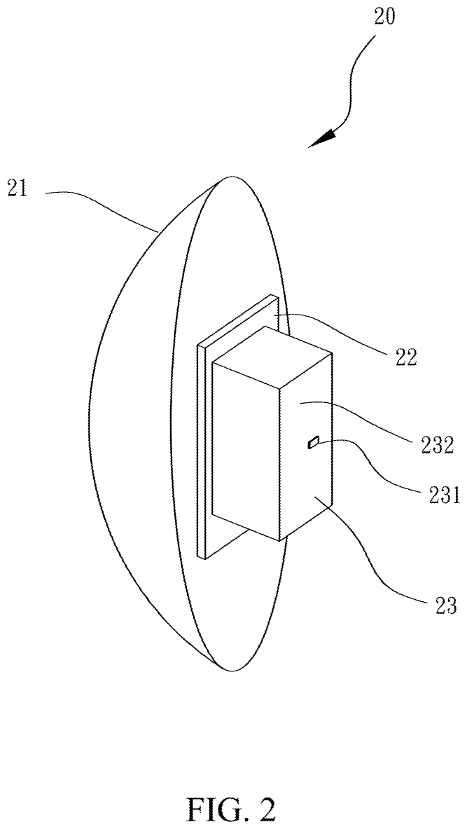

FIG. 2 is a schematic diagram of a robot using a liquid crystal display panel in the present invention. As shown in FIG. 2, the robot 20 using the liquid crystal display panel in the present invention mainly includes a mask 21, a liquid crystal display panel 22 and a high-directional backlight module 23.

The mask 21 is a human-like face mask. For example, the mask 21 in the present invention can be made of plastic materials via a rapid prototyping machine for model printing. How to make a human-like face mask is known to those with ordinary skill in the art, so the description thereof is omitted herein. The mask 21 has a simple face shape of eyes, ears, mouth, nose or other organs. The liquid crystal display panel 22 is disposed on an inner side of the mask 21. The liquid crystal display panel 22 can be fixedly disposed on the inner side of the mask 21 when the robot is assembled. The liquid crystal display panel 22 is used for projecting images onto the mask 21. The backlight module 23 is disposed on one lateral side of the liquid crystal display panel 22 and is used to provide a high-directional backlight to the liquid crystal display panel 22, so that the images generated by the liquid crystal display panel 22 can be projected onto the mask 21. In the preferred embodiment of the present invention, the backlight module 23 is preferably a collimated backlight module, but in different embodiments, the backlight module 23 in the present invention may also be other types of backlight modules, and it is not limited herein.

Specifically, the high-directional backlight module 23 in the present invention includes a point light source generator 231 and a light guide element 232. The point light source generator 231 is used to generate a point light source and transmit the point light source to the light guide element 232. The light guide element 232 receives the point light source and converts the point light source into a very high-directional backlight.

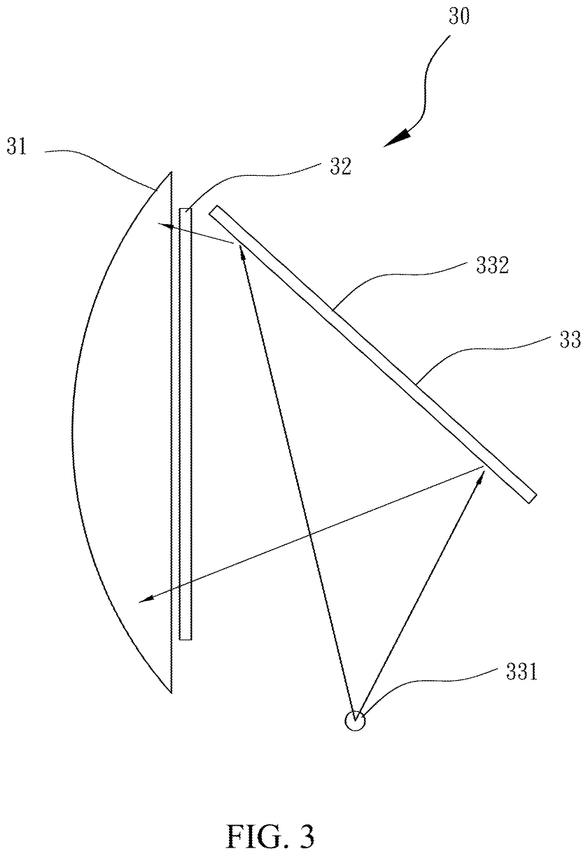

FIG. 3 is a schematic diagram of a robot using a liquid crystal display panel according to the first embodiment of the backlight module in the present invention. As shown in FIG. 3, the robot 30 using the liquid crystal display panel according to the first embodiment of the present invention includes a mask 31 and a liquid crystal display panel 32 and a high-directional backlight module 33. In this embodiment, the light source generator 331 of the backlight module 33 is a point light source generator, which is disposed under the liquid crystal display panel 32, and a light guide element 332 is disposed at one lateral side of the liquid crystal display panel 32. The light guide element 332 is not arranged parallel to the liquid crystal display panel 32. The light guide element 332 is inclined at an angle with respect to the liquid crystal display panel 32. The inclination angle can be changed according to the size of the liquid crystal display panel 32. The light guide element 332 is a mirror (e.g. a reflector). The point light source generated by the light source generator 331 is transmitted to the light guide element 332, and then the point light source is uniformly reflected to the liquid crystal display panel 32 through the light guide element 332.

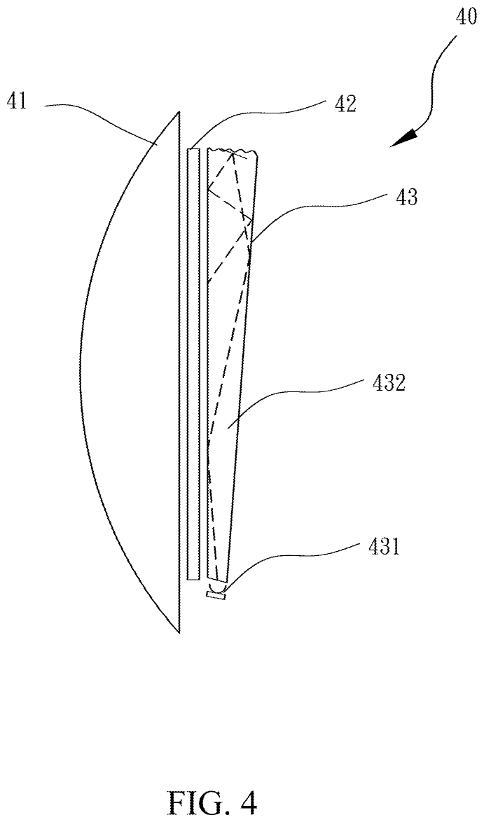

FIG. 4 is a schematic diagram of a robot using a liquid crystal display panel according to the second embodiment of the backlight module in the present invention. As shown in FIG. 4, in the second embodiment of the present invention, the robot 40 using the liquid crystal display panel includes a mask 41, a liquid crystal display panel 42 and a high-directional backlight module 43. In this embodiment, the light source generator 431 of the backlight module 43 is also a point light source generator, which is disposed under the liquid crystal display panel 42 and close to the liquid crystal display panel 42. The light guide element 432 is disposed at one lateral side of the liquid crystal display panel 42, and the light emitting surface of the light guide element 432 is arranged parallel to the liquid crystal display panel 42. The light guide element 432 is a wedge-shaped light guide plate. The point light source generated by the light source generator 431 is transmitted from one end of the wedge-shaped light guide plate into the wedge-shaped light guide plate, and then the light source is uniformly directed to the liquid crystal display panel 42 through many times of total internal reflection inside the wedge-shaped light guide plate.

In addition, it should be noted that the light source generator in the present invention can be a laser light source with etendue limited. The blue laser light source is focused on the phosphor plate to excite yellow light. Then, the blue laser is fused with the excited yellow light to produce white light, which is collected at one point and enters the wedge-shaped light guide plate as shown in FIG. 4. Alternatively, the point light source can be made from small area light emitting diodes (RGB LEDs) used in a pico-projector. The RGB light source generated by the small area light emitting diodes is transmitted to the dichroic mirror for RGB light combination. After that, the light source is focused at one point, and then enters the wedge-shaped light guide plate (light guide element 432) as shown in FIG. 4. The aforementioned description is only an example to show how the light source generator in the present invention generates a point light source and then transmits it to the light guide element. It is not intended to limit only the aforementioned light source generator can generate a point light source, and any light sources are capable of generating a point light source can be the light source generator in the present invention, and it is not limited herein.

Through the robot using the liquid crystal display panel in the present invention, the liquid crystal display panel is used to replace the general projector to reduce the internal space of the robot and also make the face design of the robot more flexible.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

1. A robot using liquid crystal display (LCD) panel comprising:
a human-like face mask;
an LCD panel disposed at an inner side of the human-like face mask and projecting images on the human-like face mask; and
a high-directional backlight module disposed at one lateral side of the LCD panel and configured to provide a very high-directional backlight for the LCD panel, so that the images generated by the LCD panel being able to distinctly project to the human-like face mask and the images being displayed on the human-like face mask.

2. The robot using the LCD panel of claim 1, wherein the human-like face mask is a curved diffusing plate with 3D shapes of eyes, mouth and nose.

3. (canceled)

4. The robot using the LCD panel of claim 1, wherein the high-directional backlight module includes:
a light source generator configured to generate a point light source; and
a light guide element configured to receive the point light source;
wherein the point light source is converted to a very high-directional backlight by the light guide element and uniformly transmitted on a light emitting surface of the light guide element.

5. The robot using the LCD panel of claim 4, wherein the light guide element is a mirror light guide plate or a reflector.

6. The robot using the LCD panel of claim 5, wherein the mirror light guide plate is inclined at an angle with respect to the LCD panel.

7. The robot using the LCD panel of claim 6, wherein the point light source generated by the light generator is transmitted to the mirror light guide plate and the point light source is uniformly reflected by the mirror light guide plate to the LCD panel.

8. The robot using the LCD panel of claim 4, wherein the light guide element is a wedge-shaped light guide plate, and the light emitting surface of the wedge-shaped light guide plate is arranged parallel to the LCD panel and the point light source generated by the light generator is transmitted from one end of the wedge-shaped light guide plate into the wedge-shaped light guide plate and then the point light source is reflected inside the wedge-shaped light guide plate to be uniformly transmitted to the LCD panel.

9. The robot using the LCD panel of claim 8, wherein the point light source is a blue laser light source with etendue limited, and the point light source is focused on the phosphor plate to excite yellow light, then the blue laser light is fused to produce white light transmitted to the wedge-shaped light guide plate.

10. The robot using the LCD panel of claim 8, wherein the light source is generated by a RGB light emitting diode (LED) used by a pico-projector, and the RGB light source is transmitted to a dichroic mirror to combine light, then focus at one point and enter the wedge-shaped light guide plate.
